(19) United States
(12) Patent Application Publication
(10) Pub. No.: US 2023/0061653 A1
(43) Pub. Date: Mar. 2, 2023

(54) DETECTION CIRCUIT FOR ADJUSTING WIDTH OF OUTPUT PULSES, RECEIVING UNIT, LASER RADAR

(71) Applicant: Hesai Technology Co., Ltd., Shanghai (CN)

(72) Inventors: Xuezhou ZHU, Shanghai (CN); Chenluan WANG, Shanghai (CN); Wenyi ZHU, Shanghai (CN); Shaoqing XIANG, Shanghai (CN)

(21) Appl. No.: 17/963,362

(22) Filed: Oct. 11, 2022

Related U.S. Application Data
(63) Continuation of application No. PCT/CN2021/078771, filed on Mar. 2, 2021.

(30) Foreign Application Priority Data
Apr. 22, 2020 (CN) 202010322983.6

(51) Int. Cl. G01S 7/484; G01S 7/481; G01S 17/10

(52) U.S. Cl. CPC G01S 7/484; G01S 7/4816; G01S 7/4814; G01S 17/10

(57) ABSTRACT

A detection circuit for adjusting a width of output pulses is provided, including: a single-photon avalanche diode configured to generate a photocurrent according to an incident photon; and a comparator, having a first input terminal to receive a signal indicating an adjustable threshold, and a second input terminal coupled to the single-photon avalanche diode to receive an electrical signal representing the photocurrent. The comparator outputs a waveform based on a comparison result between the electrical signal and the signal indicating the adjustable threshold. When a plurality of photons are received by the single-photon avalanche diode within a short time period, a pulse width of an output signal of the circuit is increased. A number of photons can be obtained according to the pulse width of the signal, and a dynamic range of the single-photon avalanche diode device is improved. A pulse width of a single-photon signal can be adjusted.

### CROSS-REFERENCE

This application is a Continuation application of International PCT Application No. PCT/CN2021/078771, filed on Mar. 2, 2021, which claims the benefit of Chinese Application No. 202010322983.6, filed on Apr. 22, 2020, each of which is entirely incorporated herein by reference.

### TECHNICAL FIELD

The present invention generally relates to the field of photoelectric technologies, and in particular, to a detection circuit for adjusting the width of output pulses. The present invention further relates to a receiving unit and a laser radar that include the detection circuit, and a method of detecting return pulses.

### BACKGROUND

Currently, single-photon avalanche diode (SPAD) units used in ranging applications by laser radar may be grouped into two types: an active-quenching type and a passive-quenching type. The passive-quenching SPAD unit is shown in FIG. 1A. When a photon arrives, a diode 1 as shown in FIG. 1A biased in a Geiger mode may be triggered to avalanche, generating an avalanche current 101 as shown in FIG. 1B which generates a voltage across a quenching resistor R (e.g., waveform 102 in FIG. 1B). Afterwards, the avalanche is quenched while a node 2 is discharged back to a ground potential by the quenching resistor R, and the diode 1 returns to a Geiger bias region. A waveform of the node 2 passes through a buffer and is converted into a digital pulse with a certain driving capability, which is outputted to a subsequent processing circuit (e.g., waveform 103 in FIG. 1B). The buffer is generally composed of multi-stage inverters with a constant flipping threshold. The active-quenching SPAD unit is shown in FIG. 2. When the photon (e.g., waveform 201 in FIG. 2B) arrives, a diode 21 biased in the Geiger mode may be triggered to avalanche. At this time, an NMOS transistor connecting an anode of the diode to the GND is turned off (because a gate voltage 3 of the NMOS is 0 V), and turned into a high resistance state. Therefore, the avalanche current generates a voltage at a drain of the NMOS transistor, and the avalanche is quenched. A node 22 remains a high level (e.g., waveform 202 in FIG. 2B) until the high level delayed by the TDELAY (typically, a few nanoseconds (ns) to tens of ns) propagates to a node 23 (e.g., waveform 203 in FIG. 2B), which conducts the NMOS, so that the node 22 is discharged to 0 V, and the diode returns to the Geiger bias region. A pulse width of the node 22 is approximately equal to a duration of the TDELAY. A waveform of the node 22 is converted into a digital pulse with a certain driving capability after a buffer, which is outputted to a subsequent processing circuit (e.g., waveform 204 in FIG. 2B). A dotted portion of the waveform 204 represents a dead time of the SPAD. During a time period corresponding to the dotted line regarded as a dead time, since the NMOS transistor is continuously conductive so that the node 22 is pulled to the GND, the circuit is out of a normal operation state as waiting for a photon to arrive. The circuit will not return to the operation state until the NMOS transistor returns to an off state.

In the passive-quenching SPAD unit, the flipping threshold of the buffer is constant, therefor an output pulse width is constant. When used in a laser radar, the passive-quenching SPAD is prone to saturate due to strong ambient light, causing a failure of a distance measurement. In addition, since the output pulse width cannot be adjusted and adaptive to a width of transmission pulse, an optimized signal- to-noise ratio cannot be obtained and ranging performance declines in some processing circuits. In the active-quenching SPAD unit, the pulse width cannot be expanded with a photon sequence, rendering loss of valid information for ranging and determination of an ambient light intensity. In addition, signal distortion may be caused by existence of a dead time.

The content of the background is merely technologies known to the inventor, and does not necessarily represent the prior art in the field.

### SUMMARY

The present invention provides a detection circuit for adjusting a width of output pulses, a receiving unit for a laser radar, a laser radar including the receiving unit, and a method of detecting return pulses by using the receiving unit.

The present invention provides a detection circuit for adjusting a width of output pulses, including:

a single-photon avalanche diode, configured to generate a photocurrent in response to an incident photon; and

a comparator, having a first input terminal to be inputted with a signal indicating an adjustable threshold, and a second input terminal coupled to the single-photon avalanche diode to be inputted with an electrical signal representing the photocurrent; the comparator is configured to output a waveform based on a comparison result between the electrical signal and the signal indicating the adjustable threshold.

According to an aspect of the present invention, a cathode of the single-photon avalanche diode is coupled to a high voltage, and an anode of the single-photon avalanche diode is grounded by a quenching resistor and is coupled to the second input terminal of the comparator, wherein the electrical signal is an analog voltage outputted by the single-photon avalanche diode.

According to an aspect of the present invention, a cathode of the single-photon avalanche diode is coupled to a high voltage by a quenching resistor, and an anode of the single-photon avalanche diode is grounded, and the cathode is coupled to the second input terminal of the comparator by a capacitor, wherein the electrical signal represents a variation of a cathode voltage of the single-photon avalanche diode.

According to an aspect of the present invention, the detection circuit further includes a threshold control unit, wherein the threshold control unit is configured to output the signal indicating the adjustable threshold, and is coupled to the first input terminal of the comparator to provide the signal indicating the adjustable threshold to the first input terminal.

According to an aspect of the present invention, the signal indicating the adjustable threshold increases as an intensity of an incident light increases.

The present invention further provides a receiving unit for a laser radar, including:

a detection circuit, including:

a single-photon avalanche diode, configured to generate a photocurrent in response to an incident photon; and

a comparator, having a first input terminal to be inputted with a signal indicating an adjustable threshold, and a second input terminal coupled to the single-photon avalanche diode to be inputted with an electrical signal representing the photocurrent; the comparator is configured to output a waveform based on a comparison result between the electrical signal and the signal indicating the adjustable threshold; and

a processing unit, coupled to an output terminal of the comparator of the detection circuit and configured to calculate an intensity of an incident light based on the waveform outputted by the comparator.

According to an aspect of the present invention, a cathode of the single-photon avalanche diode is coupled to a high voltage, and an anode of the single-photon avalanche diode is grounded by a quenching resistor and is coupled to the second input terminal of the comparator, and wherein the electrical signal represents a voltage across the quenching resistor.

According to an aspect of the present invention, a cathode of the single-photon avalanche diode is coupled to a high voltage by a quenching resistor, and an anode of the single-photon avalanche diode is grounded, and the cathode is coupled to the second input terminal of the comparator by a capacitor, and wherein the electrical signal represents a voltage of the single-photon avalanche diode.

According to an aspect of the present invention, the receiving unit further includes a threshold control unit, wherein the threshold control unit is coupled to the processing unit, and is configured to adjust the signal indicating the adjustable threshold according to the intensity of the incident light, and is coupled to the first input terminal of the comparator to provide the signal indicating the adjustable threshold to the first input terminal.

According to an aspect of the present invention, the threshold control unit is configured to increase the signal indicating the adjustable threshold as the intensity of the incident light increases.

According to an aspect of the present invention, the receiving unit includes a plurality of the detection circuits and a summer, wherein output terminals of comparators of the plurality of detection circuits are coupled to an input terminal of the summer, and the summer is configured to perform a summation of outputs of the plurality of detection circuits.

According to an aspect of the present invention, the signal indicating the adjustable threshold of the detection circuit is set so that a width of an output waveform of the comparator of the detection circuit corresponding to a single photon matches a width of a laser pulse of the laser radar.

According to an aspect of the present invention, the signal indicating the adjustable threshold of the detection circuit is set so that the width of the output waveform of the comparator of the detection circuit corresponding to a single photon is equal to a full width at half maximum of the laser pulse of the laser radar.

According to an aspect of the present invention, the processing unit is configured to calculate a number of incident photons based on a pulse width of the waveform outputted by the comparator.

The present invention further provides a laser radar, including:

an emitting unit, including a laser emitter configured to transmit a laser pulse to an outside of the laser radar to detect a target object;

the receiving unit as described above, configured to receive a return pulse of the laser pulse reflected by the target object; and

a calculation unit, connected to the receiving unit and configured to calculate a distance and/or a reflectivity of the target object based on the waveform outputted by the comparator of the receiving unit.

The present invention further provides a method of detecting return pulses by using the receiving unit as described above.

The present invention further provides a method of laser detection, including:

emitting a detection laser beam to detect a target object;

receiving a return pulse from the target object through a single-photon avalanche diode, wherein the single-photon avalanche diode generates a photocurrent in response to an incident photon;

comparing an electrical signal representing the photocurrent with a signal indicating an adjustable threshold through a comparator to generate a digital signal output; and

adjusting the signal indicating the adjustable threshold according to a waveform of the digital signal output.

According to an aspect of the present invention, the step of adjusting the signal indicating the adjustable threshold according to the waveform of the digital signal output includes: increasing the signal indicating the adjustable threshold as an intensity of an incident light increases.

Embodiments of the present invention provide a single-photon avalanche diode unit circuit (pixel level circuit). The unit circuit has the following two features: when a plurality of photons are received by a single-photon avalanche diode within a short time period, a pulse width of an output signal of the circuit is expanded. Therefore, a number of photons can be obtained according to the pulse width of the signal, and a dynamic range of the single-photon avalanche diode device can be improved. A pulse width of a single-photon signal can be adjusted. By virtue of the characteristic, in a dTOF ranging application, the pulse width of the single-photon signal can be configured to be close to a width of a transmission pulse for distance measurement, so that a proper “integration time window” of a processing circuit can be set to obtain an improved signal-to-noise ratio.

### BRIEF DESCRIPTION OF THE DRAWINGS

The drawings forming a part of the present disclosure are used to provide further understanding of the present disclosure, and the exemplary embodiments and description of the present disclosure are used to explain the present disclosure but do not constitute an improper limitation on the present disclosure. In the drawings:

FIG. 1A and FIG. 1B respectively show a passive-quenching single-photon avalanche diode detection circuit and a waveform thereof.

FIG. 2A and FIG. 2B respectively show an active-quenching single-photon avalanche diode detection circuit and a waveform thereof.

FIG. 3A shows a detection circuit according to an embodiment of a first aspect of the present invention.

FIG. 3B shows a schematic diagram of waveforms at each node in the detection circuit as shown in FIG. 3A.

FIG. 4 shows a schematic diagram of adjusting a pulse width by adjusting a threshold in the circuit as shown in FIG. 3A.

FIG. 5 shows a schematic diagram of improving a dynamic range of a single-photon avalanche diode device by increasing a threshold when ambient light is strong.

FIG. 6A shows a detection circuit according to another embodiment of the first aspect of the present invention.

FIG. 6B shows a schematic diagram of waveforms at each node in the detection circuit as shown in FIG. 6A.

FIG. 7 shows a schematic diagram of a receiving unit for a laser radar according to a second aspect of the present invention.

FIG. 8 shows a schematic diagram of a receiving unit according to a preferred embodiment of the second aspect of the present invention.

FIG. 9 shows a schematic diagram of waveforms at each node in the receiving unit as shown in FIG. 8 for illustrating a selection and optimization of the threshold.

FIG. 10 shows a schematic diagram of a laser radar according to a third aspect of the present invention.

FIG. 11 shows a schematic diagram of a method of laser detection according to a fourth aspect of the present invention.

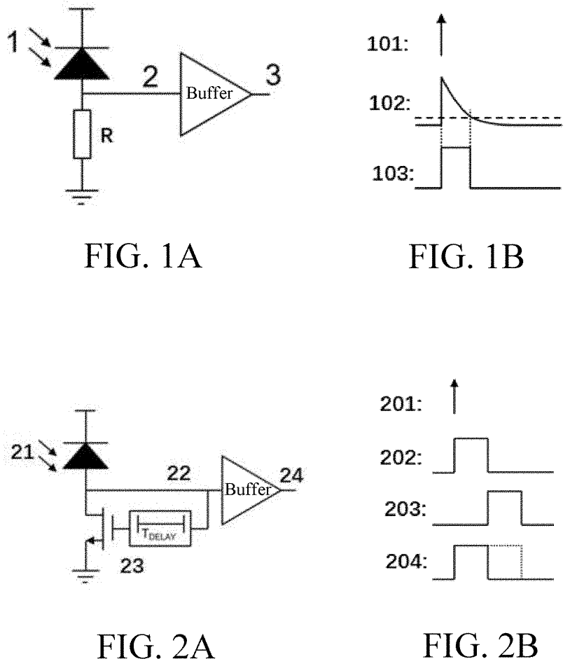

### DETAILED DESCRIPTION

Only some exemplary embodiments are briefly described below. As those skilled in the art can realize, the described embodiments may be modified in various different ways without departing from the spirit or the scope of the present invention. Therefore, the accompanying drawings and the description are to be considered as illustrative in nature but not restrictive.

In the description of the present invention, it should be understood that directions or location relationships indicated by terms “center”, “longitudinal”, “landscape”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise” are directions or location relationships shown based on the accompanying drawings, are merely used for the convenience of describing the present invention and simplifying the description, but are not used to indicate or imply that a device or an element needs to have a particular direction or needs to be constructed and operated in a particular direction, and therefore, cannot be understood as a limitation to the present invention. In addition, the terms “first” and “second” are used merely for description, and shall not be construed as indicating or implying relative importance or implying a quantity of indicated technical features. Therefore, a feature restricted by “first ” or “second” may explicitly indicate or implicitly include one or more such features. In the descriptions of the present invention, unless otherwise explicitly specified, “multiple” means two or more than two.

In the description of the present invention, it should be noted that unless otherwise explicitly specified or defined, the terms such as “mount”, “install”, “connect”, and “connection” should be understood in a broad sense. For example, the connection may be a fixed connection, a detachable connection, or an integral connection; a mechanical connection, an electrical connection, mutual communication, or the connection may be a direct connection, an indirect connection through an intermediate medium, internal communication between two components, or an interaction relationship between two components. Persons of ordinary skill in the art may understand the specific meanings of the foregoing terms in the present invention according to specific situations.

In the present invention, unless otherwise explicitly stipulated and restricted, that a first feature is “on” or “under” a second feature may include that the first and second features are in direct contact, or may include that the first and second features are not in direct contact but in contact by using other features therebetween. In addition, that the first feature is “on”, “above”, or “over” the second feature includes that the first feature is right above and on the inclined top of the second feature or merely indicates that a level of the first feature is higher than that of the second feature. That the first feature is “below”, “under”, or “beneath” the second feature includes that the first feature is right below and at the inclined bottom of the second feature or merely indicates that a level of the first feature is lower than that of the second feature.

Many different implementations or examples are provided in the following disclosure to implement different structures of the present invention. To simplify the disclosure of the present invention, components and settings in particular examples are described below. Certainly, they are merely examples and are not intended to limit the present invention. In addition, in the present invention, reference numerals and/or reference letters may be repeated in different examples. The repetition is for the purposes of simplification and clearness, and a relationship. Moreover, the present invention provides examples of various particular processes and materials, but a person of ordinary skill in the art may be aware of application of another process and/or use of another material.

Preferred embodiments of the present invention are described below in detail with reference to the accompanying drawings. It should be understood that the preferred embodiments described herein are merely used to explain the present invention but are not intended to limit the present invention.

First Aspect

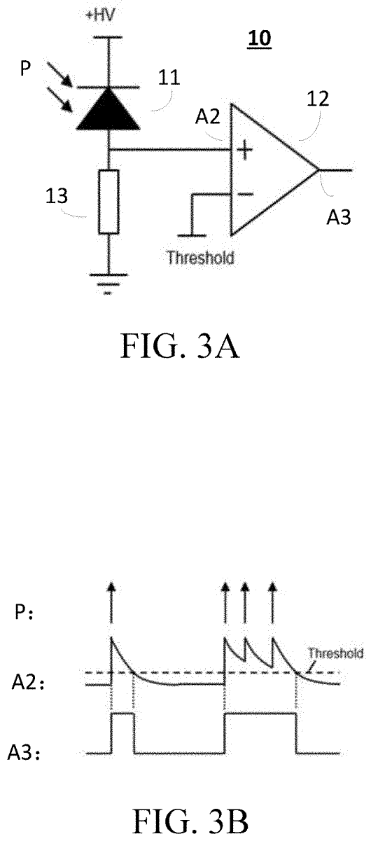

FIG. 3A shows a detection circuit 10 according to an embodiment of a first aspect of the present invention, an output pulse width of which may be adjusted and expanded to reflect a width of a transmission pulse. Detailed description is provided below with reference to FIG. 3A.

As shown in FIG. 3A, the detection circuit 10 includes a single-photon avalanche diode 11 and a comparator 12. The single-photon avalanche diode is a photodetection avalanche diode capable of single-photon detection, which operates in a Geiger mode, and can generate a photocurrent in response to an incident photon so as to be used for detection of extremely weak optical signals. A first input terminal of the comparator 12 (an inverting input terminal - of the comparator 12 in FIG. 3A) is to be inputted with a signal indicating an adjustable threshold, and a second input terminal of the comparator 12 (an in-phase input terminal +of the comparator 12 in FIG. 3) is coupled to the single-photon avalanche diode 11 to be inputted with an electrical signal representing the photocurrent. The comparator 12 outputs a waveform according to a comparison result between the electrical signal and the signal indicating the adjustable threshold. For example, the comparator outputs a high level when the electrical signal is higher than the signal indicating the adjustable threshold, and the comparator outputs a low level when the electrical signal is higher than the signal indicating the adjustable threshold, or vice versa.

As shown in FIG. 3A, according to a preferred embodiment of the present invention, the detection circuit 10 may further include a quenching resistor 13. A cathode of the single-photon avalanche diode 11 is coupled to a high voltage +HV, and an anode thereof is grounded by the quenching resistor 13. The single-photon avalanche diode operates in the Geiger mode, and can make a response to an excitation P of an incident photon. The anode of the single-photon avalanche diode 11 is further coupled to the second input terminal (the in-phase input terminal +) of the comparator 12, so as to provide the comparator 12 with an analog voltage outputted by the single-photon avalanche diode 11 as an electrical signal. The circuit structure as shown in FIG. 3A may be applied to a single-photon avalanche diode device with a P-on-N structure, of which an anode is not required to be grounded, so that the circuit structure may be configured according to FIG. 3A. An anode of a single-photon avalanche diode with an N-on-P structure is generally required to be grounded. A specific circuit structure thereof is described in detail below. The single-photon avalanche diodes of both the two structures can be applied in the expandable and adjustable detection circuit of the present invention.

FIG. 3B shows a waveform A2 at the in-phase input terminal of the comparator 12 and a waveform A3 at an output terminal of the comparator 12, which are generated in the circuit structure as shown in FIG. 3A when the single-photon avalanche diode 11 receives the excitation P of the incident photon. When the excitation P of the incident photon includes one photon, as shown by a single arrow in the excitation P of the incident photon in FIG. 3B, the waveform A2 at the in-phase input terminal of the comparator 12 corresponds to a signal waveform of the single photon, which includes a steeply rising leading edge and an exponentially decaying trailing edge. The steeply rising leading edge is caused by rapid avalanche and quenching which usually lasts less than 1 ns. That is to say, a rise time of a leading edge of a single-photon signal is less than 1 ns. The exponentially decaying trailing edge corresponds to a recharge process of the single-photon avalanche diode. After the avalanche is quenched by the quenching resistor, the high-voltage power supply +HV charges a junction capacitor of the single-photon avalanche diode through the quenching resistor 13 (with a resistance RQ) with a charging time constant of RQ×CD, which creates a trailing edge of the single-photon signal to decay exponentially. A Typical value of the charging time constant ranges from a few nanoseconds (ns) to tens of ns. Through the comparator 12, the output terminal of the comparator 12 generates a digital waveform A3, which has a high level when a voltage of the waveform A2 is higher than a threshold, or a low level on the contrary.

When the excitation P of the incident photon includes a plurality of consecutive photons, as shown by three adjacent arrows in the excitation P of the incident photon in FIG. 3B, the waveform A2 includes a corresponding number of single-photon signal waveforms, and each single-photon signal waveform includes a steeply rising leading edge and an exponentially decaying trailing edge, as described above. Since the plurality of consecutive photons are closely spaced, and the threshold is lower than troughs of waveforms of the plurality of consecutive single-photon signals, the waveform A3 has an expanded output signal waveform correspondingly.

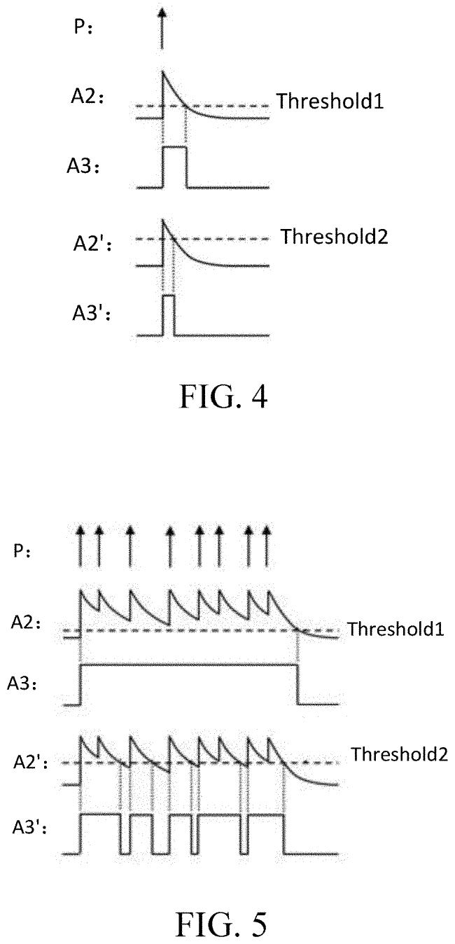

FIG. 4 is a schematic diagram of adjusting a pulse width by adjusting a threshold. As shown in FIG. 4, for the excitation P of the incident photon including one photon, when a lower threshold 1 is applied, a waveform A3 obtained at the output terminal of the comparator 12 has a much larger width; and when a higher threshold 2 is applied, a waveform A3′ obtained at the output terminal has a much smaller width. Therefore, by adjusting the flipping threshold of the comparator 12, a duration that an analog signal waveform outputted by the single-photon avalanche diode 11 exceeds the threshold can be adjusted, thereby a width of the digital pulse outputted by the detection circuit 10 including the single-photon avalanche diode can be adjusted.

The pulse width adjustment function as described above can be effectively applied in many occasions. Taking a laser radar system for example, when the ambient light is strong (as shown in FIG. 5, the excitation P of the incident photon includes a plurality of closely adjacent arrows), by increasing the threshold, a dynamic range of the single-photon avalanche diode device can be improved, so that it is less prone to saturation. Specifically, as shown in FIG. 5, when a lower threshold 1 is applied, in case of strong ambient light, the single-photon avalanche diode device 11 is frequently triggered to avalanche by incident ambient photons. As a result, before the single-photon avalanche diode 11 is fully charged after an avalanche is quenched, another avalanche is triggered. The waveform A3 reflected at the output terminal of the comparator 12 has a continuous high level, such that the detection circuit 10 cannot perform distance measurement normally, or measure an intensity of the ambient light accurately. After a higher threshold 2 is applied, a signal of the waveform A3′ at the output terminal of the comparator 12 can change from the continuous high level to a random pulse output. In this case, although noise caused by the ambient light is relatively high, the single-photon avalanche diode device is not completely saturated and still retains a certain ranging capability (generally, a plurality of measurements are required at high noise level to improve a signal-to-noise ratio so as to extract an effective signal) and can evaluate an actual intensity of the ambient light through information such as a pulse width and a frequency of the noise.

Those skilled in the art can easily understand that, in the above embodiment, the comparator 12 is a voltage comparator, but the present invention is not limited thereto. The voltage comparator is merely an embodiment. The comparator may alternatively be a current comparator, or other types of circuit structures with a configurable flipping threshold (action threshold).

In the above embodiment of the present invention, the comparator with a configurable threshold is applied to the passive-quenching SPAD unit, which also acts as a buffer with the output of a certain driving capability to drive a subsequent processing circuit. In this way, the output signal of the single- photon signal has the following two features: the width of the single-photon signal can be changed by adjusting the threshold; the output signal can be expanded with the photon sequence when a continuous photon sequence arrives. Those skilled in the art understand that, the expansion of the output signal within some extent is beneficial, and can be used to determine an intensity of an incident light or ambient light. A specific expansion extent may be determined according to specific usage scenarios which is not limited in the present invention.

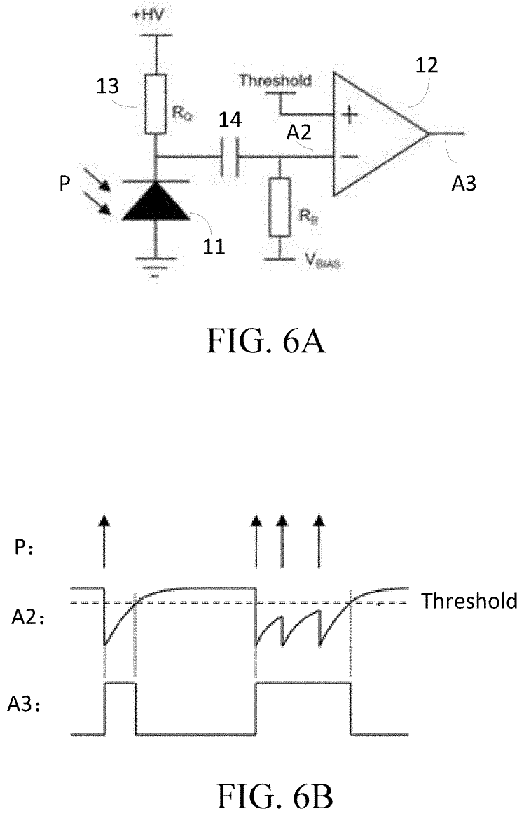

FIG. 6A shows a detection circuit 10 according to another embodiment of the present invention. A circuit structure as shown in FIG. 6 is applicable to a single-photon avalanche diode with a N-on-P structure of which an anode is generally required to be grounded. As shown in FIG. 6A, the cathode of the single-photon avalanche diode 11 is coupled to the high voltage +HV by the quenching resistor 13, and the anode of the single-photon avalanche diode 11 is grounded to operate in the Geiger mode. The cathode is further coupled to the second input terminal (the inverting input terminal in the figure) of the comparator 12 through the capacitor 14, so that a variation of a cathode voltage of the single-photon avalanche diode 11 is provided to the inverting input terminal of the comparator 12 as an electrical signal. The capacitor 14 may function to block an DC current while passing an AC current, so that only the variation of the cathode voltage of the single-photon avalanche diode 11 may be provided to the inverting input terminal of the comparator 12. Likewise, the in-phase input terminal of comparator 12 is connected to the adjustable threshold. FIG. 6B shows a waveform A2 at the in-phase input terminal of the comparator 12 and a waveform A3 at the output terminal of the comparator 12 corresponding to the excitation P of the incident photon during operation of the detection circuit 10 as shown in FIG. 6A. This embodiment is similar to that described above with reference to FIG. 3A, except that in the circuit structure of FIG. 6A, the variation (that is, the waveform A2) of the cathode voltage of the single-photon avalanche diode 11 has a downward spike. A specific operation manner may refer to the description of FIG. 3A above, and details are not described herein.

In addition, and preferably, the detection circuit 10 further includes a bias resistor RB, and the inverting input terminal of the comparator 12 is connected to a bias voltage V_{BIAS} by the bias resistor R_{B}, as shown in FIG. 6A.

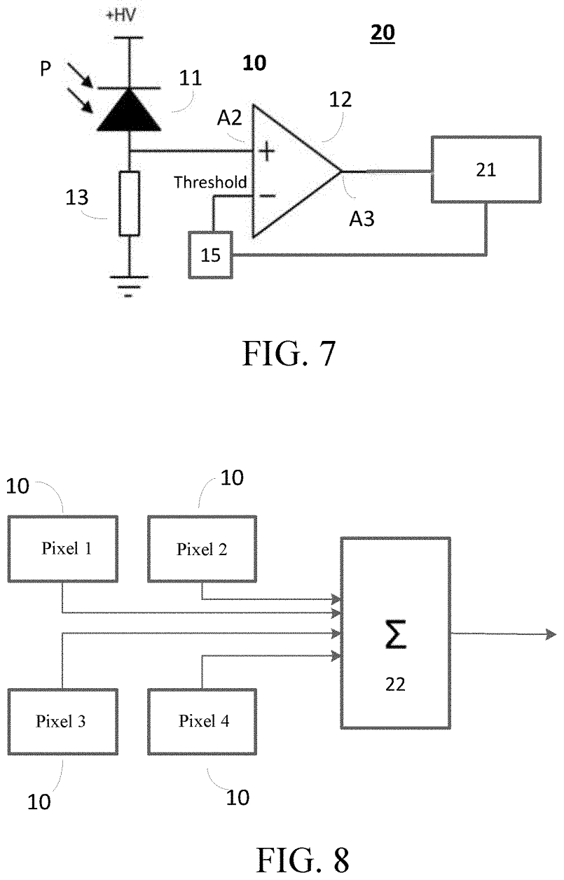

In addition, according to another preferred embodiment of the present invention, the detection circuit 10 further includes a threshold control unit. The threshold control unit is configured to generate and output the signal indicating the adjustable threshold based on the intensity of the ambient light, and is coupled to the first input terminal of the comparator to provide the signal indicating the adjustable threshold to the first input terminal. Description is provided below with reference to FIG. 7. For example, the threshold control unit may dynamically adjust the signal indicating the adjustable threshold, to change the width of the single-photon signal in the output waveform A3 of the detection circuit, and cause the output signal to be expanded with a photon sequence when a continuous photon sequence arrives.

The detection circuit of the first aspect of the present invention has been described above. When the single-photon avalanche diode is triggered by a photon, it will undergo quenching and recharging, and then return to a normal operating state. For the detection circuit unit provided in this embodiment of the present invention, if another photon or some other photons incident a photosensitive region of the single-photon avalanche diode and trigger an avalanche during recharging and recovery, the output signal of the detection circuit is expanded. Patterns of the expansion are briefly described below. A total pulse width outputted by the detection circuit 10 represents a total duration of the incident photon sequence plus a duration of a single-photon output pulse width. For example, when the single-photon output pulse width is 5 ns, and 3 photons consecutively arrive within a time duration of 7 ns, the total pulse width outputted by the detection circuit is 7 ns+5 ns=12 ns. According to the spirit of the present invention, a photon sequence means: that a maximum time interval between consecutive photons is required to be shorter than one single-photon pulse width. If a time interval between two consecutive photons in the photon sequence exceeds one single-photon pulse width, the output shall represent two output pulses instead of one extended pulse, and the photon sequence shall be considered as two photon sequences.

The expansion property plays a considerable role in an optoelectronic system. In some detection circuits of a single-photon avalanche diode without the expansion property, if other photons incident on the photosensitive region of the single-photon avalanche diode during recovery time after an avalanche (a typical value of the recovery time is a few ns to tens of ns), the output signal of the single-photon avalanche diode does not change. In other words, the recovery time of the single-photon avalanche diode is a “dead time” of the detection circuit. Therefore, when a return pulse signal is strong to a certain extent, the detection circuit of the single-photon avalanche diode without the expansion property cannot determine the strength of the signal and lose information, resulting in a ranging error and failure to measure a reflectivity. Compared with the detection circuit of the single-photon avalanche diode without the expansion property, the expansion property of the present invention can help to obtain additional information and distinguish whether the output pulse is resulted from a single photon or a plurality of consecutive photons according to a width of an output pulse. Therefore, a dynamic range of the single-photon avalanche diode detection circuit is improved, and pulse intensity information can still be obtained in case of a strongly saturated signal, with which a more accurate result of ranging and measurement of a reflectivity of the target object can be obtained.

Second Aspect

The second aspect of the present invention relates to a receiving unit 20 for a laser radar, including the detection circuit 10 as described above and a processing unit 21, as shown in FIG. 7. The detection circuit 10 shown in FIG. 7 may be the same as that shown in FIG. 3A, but the present invention is not limited thereto. The detection circuit may alternatively be the detection circuit 10 shown in FIG. 6A. All of these embodiments fall within the protective scope of the present invention.

The detailed structure and operation method of the detection circuit 10 are the same as those described in detail above with reference to FIG. 3A to FIG. 6B, and the details are not described herein. The detection circuit 10 generates a digital waveform A3 at the output terminal of the comparator 12 in response to the excitation P of the incident photon. The processing unit 21 is coupled to the output terminal of the comparator 12 of the detection circuit 10, and thus can receive the digital waveform A3 and calculate an intensity of the excitation P of the incident photon according to the waveform. According to an embodiment of the present invention, the processing unit is 21 configured to calculate a number of incident photons based on a pulse width of the waveform 12 outputted by the comparator, thereby acquiring the reflectivity of the target object according to a calculation result.

In addition, as shown in FIG. 7, the detection circuit 10 further includes a threshold control unit 15. The threshold control unit 15 is coupled to the processing unit 21, and is configured to adjust the signal indicating the adjustable threshold according to an intensity of an incident light, and is coupled to the first input terminal 15 of the comparator 12 to provide the signal indicating the adjustable threshold to the first input terminal. For example, the threshold control unit 15 may increase the signal indicating the adjustable threshold as the intensity of the incident light increases. Preferably, the intensity of the incident light may be divided into a plurality of intervals, each of which corresponds to one signal indicating an adjustable threshold. A stronger intensity of an incident light corresponds to a higher signal indicating an adjustable threshold. The threshold control unit 15 may select a proper signal indicating an adjustable threshold according to an interval where the current intensity of the incident light is located.

FIG. 8 shows a preferred embodiment according to the present invention. The receiving unit 20 of the laser radar includes a plurality of detection circuits 10 and a summer 22, defined as a detection channel. Each detection circuit constitutes a pixel. FIG. 8 schematically shows four pixels 1-4. Those skilled in the art can easily understand that, FIG. 8 is a schematic example. In a ranging circuit based on a single-photon avalanche diode array, a plurality of single-photon avalanche diodes are usually combined as a channel (or referred to as a macrocell). In an example in the following figure, one channel/macrocell includes four single-photon avalanche diodes, but the present invention is not limited thereto. One channel may be composed of one or more single-photon avalanche diodes. As shown in FIG. 8, output terminals of comparators 12 of the plurality of detection circuits 10 are all connected to an input terminal of the summer 22, which is configured to performs a summation of outputs of the plurality of detection circuits. An output terminal of the summer 22 may be connected to the processing unit 21 (not shown in the figure), for example. Through the summation operation of the summer 22, valid signals can be accumulated, so that the signal output is enhanced and a signal-to-noise ratio is improved.

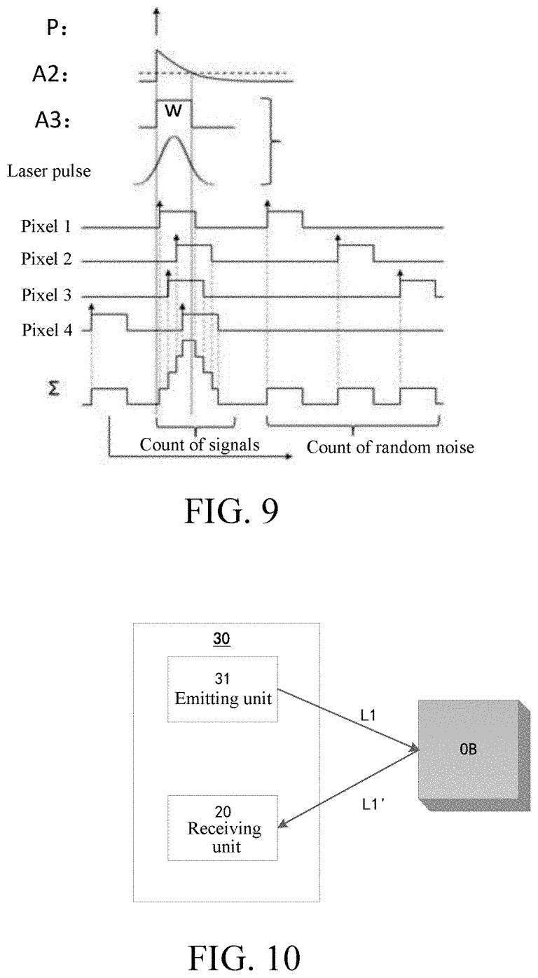

In addition, and preferably, by adjusting an output pulse width of the single-photon signal to match a width of a transmission pulse of the laser radar, the signal-to-noise ratio can be further optimized and improved. In the circuit structure of FIG. 8, digital output signals of the plurality of pixels are summed (Σ). When the accumulated result exceeds a numerical threshold, a valid signal will be determined to have been generated at that moment, that is, a valid ranging return pulse is received. The determination of the ranging pulse signal is based on an assumption that noise signal caused by the ambient light or dark counts of the single-photon avalanche diode are randomly distributed on a time axis (a horizontal direction in FIG. 9), so that it is unlikely for the noise signal to occur simultaneously within a very narrow time window (a few ns). Therefore, when a plurality of the detection circuits 10 of single-photon avalanche diodes simultaneously generate an output signal within a narrow time window (and thus accumulated to a relatively large value), the signal is highly likely to be caused by a valid return pulse signal. Further, the processing circuit and an algorithm program may extract ranging information, reflectivity information of a target object, and the like required to be collected by the laser radar, through a pulse trigger time and a pulse waveform summed up from the output signals of the plurality of pixels. In some embodiments of the present invention, by adjusting a threshold in a single pixel, a width of the digital pulse signal outputted by the pixel may be adjusted. When the width is matched with a width of a laser pulse, a more optimized ranging signal-to-noise ratio and an improved probability of detection can be obtained. According to a preferred embodiment of the present invention, the threshold is adjusted so that a time width of the digital signal outputted by each pixel (or the detection circuit) in response to a single-photon incidence is equal to a full width at half maximum of the laser pulse. At this time, most of energy of the optical pulse signal emitted by the laser emitter is concentrated in a time window corresponding to the full width at half maximum, and the processing circuit shown in FIG. 8 may accumulate a count of incidence single photons within the time window. In a ranging application, the pulse width of the single-photon signal can be configured to be close to a width of a transmission pulse for distance measurement, so that a proper “integration time window” of a processing circuit can be set to obtain an improved desirable signal-to-noise ratio. In other words, by setting the pulse width of the output signal, a length of the integration time window is set, during which the single-photon events may be accumulated by the processing circuit. If the integration time window is set to be narrower than the laser pulse, the emitted light energy will be wasted because most of the emitted valid signals are not collected, resulting the ranging signal-to-noise ratio and the detection probability decreased. If the integration time window is set to be wider than the laser pulse, a total signal amount does not change significantly, but a total amount of noise entering the wider time window will increase, reducing the ranging signal-to-noise ratio and the detection probability. Therefore, there is an optimal width of the integration time window, which can be selected by adjusting the pulse width of the output signal of the detection circuit of the single-photon avalanche diode, thereby obtaining an optimized ranging signal-to-noise ratio and detection probability. Therefore, the signal-to-noise ratio of the circuit can be improved by setting the signal indicating the adjustable threshold of the detection circuit so that a width of an output waveform of the comparator of the detection circuit corresponding to a single photon matches the width of the laser pulse of the laser radar. Preferably, a width of an output waveform of the comparator of the detection circuit corresponding to a single photon is equal to the full width at half maximum of the laser pulse of the laser radar.

Detailed description is provided referring to a waveform shown in FIG. 9. In FIG. 9, the time width w of the digital output signal of each pixel (e.g., the waveform A3 outputted by the detection circuit) is equal to the full width at half maximum of the laser pulse, as shown by waveforms of pixel 1 to pixel 4. During the time width w, the four pixels generate outputs (e.g., rising edges of the outputs of the four pixels all fall within the time width), thereby a height of a waveform outputted by the summer 22 is four times of that of a single pixel through a summation by the summer 22. Since noise signals are unlikely to occur simultaneously within the time width w, the outputs of the noise signals are usually not accumulated, so that a height of a waveform outputted by the summer is only that of a single pixel even through the summer. In this case, the signal-to-noise ratio of the detection unit may be represented as 4. If the threshold is further increased to reduce the time width w of the digital output signal of each pixel (e.g., the waveform A3 outputted by the detection circuit), not all of the outputs generated by the four pixels within the time width w can be accumulated, so that the height of the waveform outputted by the summer 22 is less than four times of that of a single pixel, which may be double or triple for instance. In this case, the signal-to-noise ratio will be significantly decreased. On the contrary, if the threshold is further reduced to increase the time width w of the digital output signal (e.g., the signal waveform A3) of each pixel, although all of the outputs generated by the four pixels within the time width w can be accumulated and the height of the waveform outputted by the summer 22 is equal to four times of that of a single pixel, the signal-to noise ratio will still be decreased due to the noise signals within the time width w possibly accumulated by the summer.

The expansion property plays a considerable role in in an optoelectronic system. In some detection circuits of a single-photon avalanche diode without the expansion property, if other photons incident on the photosensitive region of the single-photon avalanche diode during recovery after an avalanche (a typical value of the recovery time is a few ns to tens of ns), the output signal of the single-photon avalanche diode does not change. In other words, the recovery time of the single-photon avalanche diode is a “dead time” of the detection circuit. Therefore, when a return pulse signal is strong to a certain extent, the detection circuit of the single-photon avalanche diode without the expansion property cannot determine the strength of the signal, resulting in a ranging error and failure to measure a reflectivity. Compared with the detection circuit of the single-photon avalanche diode without the expansion property, the expansion property of the present invention can help to obtain additional information and distinguish whether the output pulse is resulted from a single photon or a plurality of consecutive photons according to a width of an output pulse. Therefore, a dynamic range of the single-photon avalanche diode detection circuit is improved, and pulse intensity information can still be obtained in case of a strongly saturated signal, with which a more accurate result of ranging and measurement of a reflectivity of the target object can be obtained.

When an excessively strong current return pulse signal detected by the receiving unit, the flipping threshold of the SPAD may be turned up to obtain more accurate information of signal light pulse, as described above with reference to FIG. 4.

In addition, those skilled in the art understand that the above-mentioned receiving unit 20 may operate as a unit each corresponding to a channel. An array of single-photon avalanche diodes may be constituted by a plurality of units arranged in an array, and thereby constitute a plurality of receiving channels of the laser radar to measure incident light. All of these embodiments fall within the protective scope of the present invention.

The present invention further relates to a method of detecting return pulses by using the above receiving unit.

In addition, when applied in a laser radar, an output pulse width and a recovery time of the detection circuit of the single-photon avalanche diode are required to be minimized so as to increase a dynamic range of the single-photon avalanche diode device, thereby the single-photon avalanche diode device may be less prone to be saturated by ambient light noise. Some designs are required to minimize the output pulse width and the recovery time of the single-photon avalanche diode detection circuit. In the detection circuit of the single-photon avalanche diode of the present patent, a recovery time (or referred to as the quenching time constant) depends on a quenching resistance value and a junction capacitance of the single-photon avalanche diode. The quenching time constant can be shortened by reducing the quenching resistance or the junction capacitance of the diode. An excessively small quenching resistance may result in a failure of quenching, and thereby a lower limit of the quenching resistance is generally tens of k ohms. To reduce the junction capacitance, an area of photosensitive surface of the single-photon avalanche diode is usually required to be reduced, which means that more single-photon avalanche diode units can be placed within a same total area of photosensitive surface, which further improves a dynamic range of a channel/macrocell (less prone to be saturated by ambient light). Therefore, according to the preferred embodiment of the present invention, when applied in a laser radar, an area of photosensitive surface of one single-photon avalanche diode is generally no more than 500 um².

Third Aspect

FIG. 10 shows a laser radar 30 according to the third aspect of the present invention. As shown in the figure, the laser radar 30 includes an emitting unit 31 and the receiving unit 20 as described above. The emitting unit 31 includes a laser emitter array configured to emit a plurality of laser beams for detecting a target object OB. Diffuse reflection will occur when the laser beam incident on the target object OB, and some reflected return pulses may return to the laser radar and be received by the receiving unit 20. As shown above, the receiving unit 20 includes the single-photon avalanche diode and the comparator, and can receive the return pulses of the laser beam reflected by the detected target object OB and convert the return pulses to digital signal outputs. Those skilled in the art can easily understand that the emitting unit 31 may further include an emitting lens set (although not shown) located downstream of an optical path of the laser emitter array, for modulating (collimating) the laser beam emergent from the laser emitter array into parallel light and emitting the parallel light into an ambient space around the laser radar 30. Likewise, the receiving unit 20 may further include a receiving lens set where the single-photon avalanche diode is located on a focal plane, for converging the return pulses of the emergent laser beam reflected by the detected target object OB onto the single-photon avalanche diode. As shown in the figure, diffuse reflection occurs when a laser beam L1 emitted by the emitting unit 31 is incident on the target object OB, and a part of the laser beam is reflected back as a return pulse L1′. The receiving unit 20 receives the reflected return pulse L1′ and converts it to an electrical signal. A processing unit 21 of the receiving unit 20 is configured to calculate a distance from and/or a reflectivity of the target object based on the waveform outputted by the comparator of the receiving unit. For example, the processing unit 21 may calculate the distance from the target object based on a time of flight TOF (a time period between the emission by the laser emitter and the receipt by the single-photon avalanche diode) of the return pulse and the speed of light. Additionally, or alternatively, the processing unit 21 may calculate the reflectivity of the target object based on a pulse width of the signal.

Fourth Aspect

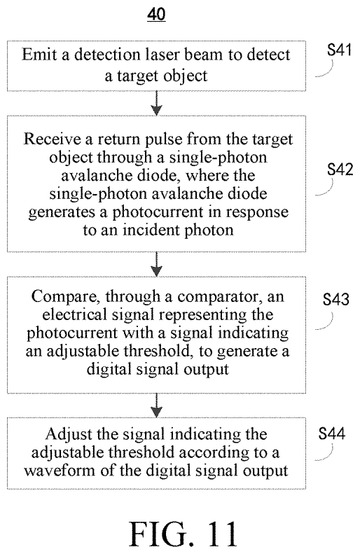

The fourth aspect of the present invention provides a method 40 for laser detection, as shown in FIG. 11. The method is described in detail below with reference to FIG. 11.

Step S41: Emit a detection laser beam to detect a target object.

Step S42: Receive a return pulse from the target object through a single-photon avalanche diode, where the single-photon avalanche diode generates a photocurrent in response to an incident photon.

Step S43: Compare, through a comparator, an electrical signal representing the photocurrent with a signal indicating an adjustable threshold, to generate a digital signal output.

Step S44: Adjust the signal indicating the adjustable threshold according to a waveform of the digital signal output.

According to a preferred embodiment of the present invention, the step of adjusting the signal indicating the adjustable threshold according to the waveform of the digital signal output includes: increasing the signal indicating the adjustable threshold as an intensity of an incident light increases. The intensity of the incident light may be obtained according to the waveform of the digital signal output when that of the comparator is obtained, and may be evaluated by calculating a number of incident photons for instance. Then the signal indicating the adjustable threshold may be simultaneously increased according to the increase of the intensity.

The preferred embodiments of the four aspects of the present invention have been described in detail above. With the solution of the preferred embodiments of the present invention, when the ambient light is relatively strong, the threshold of the detection circuit is increased to improve the dynamic range of a single-photon avalanche photodiode device so that it is less prone to be saturated. By adjusting the output pulse width of the single-photon signal to match the width of the transmission pulse of the laser radar, an optimized signal-to-noise ratio is achieved. Compared with the detection unit of the single-photon avalanche photodiode diode without the expansion property, the expansion property can help obtain additional information and distinguish whether the output pulse is resulted from a single photon or a plurality of consecutive photons according to a width of an output pulse. Therefore, the dynamic range of the single-photon avalanche photodiode device is improved, and pulse intensity information can be obtained in case of a strongly saturated signal, with which a more accurate result of ranging and measurement of a reflectivity of the target object can be obtained. In addition, by adjusting the output pulse width of the single-photon signal to match the width of the transmission pulse of the laser radar, an optimized signal-to-noise ratio can be realized.

It should be finally noted that the above descriptions are merely preferred embodiments of the present invention, but not intended to limit the present invention. Although the present invention has been described in detail with reference to the above-mentioned embodiments, a person of ordinary skill in the art can make modifications to the technical solutions described in the above-mentioned embodiments, or make equivalent replacements to some technical features in the technical solutions. Any modification, equivalent replacement, or improvement made within the spirit and principle of the present invention shall fall within the protective scope of the present invention.

1. A detection circuit for adjusting a width of output pulses, comprising:
a single-photon avalanche diode, configured to generate a photocurrent in response an incident photon; and
a comparator, having a first input terminal to be inputted with a signal indicating an adjustable threshold, and a second input terminal coupled to the single-photon avalanche diode to be inputted with an electrical signal representing the photocurrent; the comparator is configured to output a waveform based on a comparison result between the electrical signal and the signal indicating the adjustable threshold.

2. The detection circuit according to claim 1, wherein a cathode of the single-photon avalanche diode is coupled to a high voltage, and an anode of the single-photon avalanche diode is grounded by a quenching resistor and is coupled to the second input terminal of the comparator, wherein the electrical signal is an analog voltage outputted by the single-photon avalanche diode.

3. The detection circuit according to claim 1, wherein a cathode of the single-photon avalanche diode is coupled to a high voltage by a quenching resistor, and an anode of the single- photon avalanche diode is grounded, and the cathode is coupled to the second input terminal of the comparator by a capacitor, wherein the electrical signal represents a variation of a cathode voltage of the single-photon avalanche diode.

4. The detection circuit according to claim 3, further comprising a threshold control unit, wherein the threshold control unit is configured to output the signal indicating the adjustable threshold, and is coupled to the first input terminal of the comparator to provide the signal indicating the adjustable threshold to the first input terminal.

5. The detection circuit according to claim 3, wherein the signal indicating the adjustable threshold increases as an intensity of an incident light increases.

6. A receiving unit for a laser radar, comprising:
a detection circuit, comprising:
a single-photon avalanche diode, configured to generate a photocurrent in response to an incident photon; and
a comparator, having a first input terminal to be inputted with a signal indicating an adjustable threshold, and a second input terminal coupled to the single-photon avalanche diode to be inputted with an electrical signal representing the photocurrent; the comparator is configured to output a waveform based on a comparison result between the electrical signal and the signal indicating the adjustable threshold; and
a processing unit, coupled to an output terminal of the comparator of the detection circuit and configured to calculate a distance from a target obj ect and/or an intensity of an incident light based on the waveform outputted by the comparator.

7. The receiving unit according to claim 6, wherein a cathode of the single-photon avalanche diode is coupled to a high voltage, and an anode of the single-photon avalanche diode is grounded by a quenching resistor and is coupled to the second input terminal of the comparator, and wherein the electrical signal represents a voltage across the quenching resistor.

8. The receiving unit according to claim 6, wherein a cathode of the single-photon avalanche diode is coupled to a high voltage by a quenching resistor, and an anode of the single- photon avalanche diode is grounded, and the cathode is coupled to the second input terminal of the comparator by a capacitor, and wherein the electrical signal represents a voltage of the single-photon avalanche diode.

9. The receiving unit according to claim 8, further comprising a threshold control unit, wherein the threshold control unit is coupled to the processing unit, and is configured to adjust the signal indicating the adjustable threshold according to the intensity of the incident light, and is coupled to the first input terminal of the comparator to provide the signal indicating the adjustable threshold to the first input terminal.

10. The receiving unit according to claim 9, wherein the threshold control unit is configured to increase the signal indicating the adjustable threshold as the intensity of the incident light increases.

11. The receiving unit according to claim 8, wherein the receiving unit comprises a plurality of the detection circuits and a summer, wherein output terminals of comparators of the plurality of detection circuits are coupled to an input terminal of the summer, and the summer is configured to perform a summation of outputs of the plurality of detection circuits.

12. The receiving unit according to claim 8, wherein the signal indicating the adjustable threshold of the detection circuit is set so that a width of an output waveform of the comparator of the detection circuit corresponding to a single photon matches a width of a laser pulse of the laser radar.

13. The receiving unit according to claims to 12, wherein the signal indicating the adjustable threshold of the detection circuit is so such that the width of the output waveform of the comparator of the detection circuit corresponding to a single photon is equal to a full width at half maximum of the laser pulse of the laser radar.

14. The receiving unit according to claim 8, wherein the processing unit is configured to calculate a number of incident photons based on a pulse width of the waveform outputted by the comparator.

15. A laser radar, comprising:
an emitting unit, comprising a laser emitter configured to transmit a laser pulse to an outside of the laser radar to detect a target object; and
the receiving unit according to claim 6, configured to receive a return pulse of the laser pulse reflected by the target object.

16. A method of detecting return pulses by using the receiving unit according to any of claims 6 to 14.

17. A method of laser detection, comprising:
emitting a detection laser beam to detect a target object;
receiving a return pulse from the target object through a single-photon avalanche diode, wherein the single-photon avalanche diode generates a photocurrent in response to an incident photon;
comparing an electrical signal representing the photocurrent with a signal indicating an adjustable threshold through a comparator to generate a digital signal output; and
adjusting the signal indicating the adjustable threshold according to a waveform of the digital signal output.

18. The receiving unit according to claim 17, wherein the step of adjusting the signal indicating the adjustable threshold according to the waveform of the digital signal output comprises: increasing the signal indicating the adjustable threshold as an intensity of an incident light increases.
